(19) United States
(12) Patent Application Publication
(10) Pub. No.: US 2024/0051091 A1
(43) Pub. Date: Feb. 15, 2024

(54) CLAMPING DEVICE

(71) Applicant: CRAFTGEEK LLC, Irvine, CA (US)

(72) Inventor: Meihua Xia, Shenzhen (CN)

(21) Appl. No.: 17/819,293

(22) Filed: Aug. 11, 2022

(51) Int. Cl. B25B 5/16; B25B 5/06; B25B 5/00

(52) U.S. Cl. CPC B25B 5/166; B25B 5/163; B25B 5/067; B25B 5/006

(57) ABSTRACT

The utility model relates to the field of a photographing support apparatus, in particular to a clamping device, including: a lower clamping portion, an upper clamping portion corresponding to the lower clamping portion, a clamping arm connecting the upper clamping portion with the upper clamping portion, and a connecting head for connecting a telescopic rod. The clamping device further includes a connecting member arranged on one side of the connecting head. A sliding groove of the clamping arm is provided on one side of the clamping arm far away from a peripheral device. A slider is slidably arranged in the sliding groove of the clamping arm. The connecting member is rotatably connected to the slider. In the clamping device of the utility model, the sliding groove of the clamping arm is arranged on the clamping arm. The slider is slidably arranged in the sliding groove of the clamping arm, so that the connecting member is rotatably connected to the slider. Therefore, after clamping the photographing apparatus, the clamping device can conveniently adjust horizontally a photographing angle. The clamping device itself is easy to be stored, thereby reducing a volume of the self-photographing apparatus, which is convenient to carry and use.

### CROSS REFERENCE TO RELATED APPLICATIONS

Not Applicable.

### STATEMENT RE: FEDERALLY SPONSORED RESEARCH/DEVELOPMENT

Not Applicable.

### BACKGROUND

The utility model relates to the field of a photographing support apparatus, in particular to a clamping device.

At present, a selfie stick has become a popular selfie device. However, after clamping a photographing apparatus, a clamping device of the selfie stick basically can only adjust a photographing angle vertically, and is inconvenient to adjust the photographing angle horizontally. Therefore, it is inconvenient to complete photographing of the photographing apparatus under different lateral deflection angles. At the same time, the clamping device still has the problem of inconvenient storage, thereby resulting in a large volume of the selfie device, which is inconvenient to carry and use.

Therefore, the prior art still needs to be improved and developed.

### BRIEF SUMMARY

In view of the above-mentioned deficiencies in the prior art, an objective of the utility model is to provide a clamping device, thereby overcoming the problems that the clamping device in the prior art cannot easily adjust a photographing angle laterally and is inconvenient to be stored after the clamping device in the prior art clamps a photographing apparatus.

The utility model has the following technical solution:

The utility model provides a clamping device, including a lower clamping portion, an upper clamping portion corresponding to the lower clamping portion, a clamping arm connecting the upper clamping portion with the upper clamping portion, and a connecting head for placing a peripheral device. The clamping device further includes a connecting member arranged on one side of the connecting head. A sliding groove of the clamping arm is provided on one side of the clamping arm far away from the connecting head. A slider is slidably arranged in the sliding groove of the clamping arm, and the connecting member is rotatably connected to the slider.

As a further preferred solution of the utility model, the upper clamping portion is fixed at one end of the clamping arm, and the lower clamping portion is slidably arranged at the other end of the clamping arm.

As a further preferred solution of the utility model, the slider is elongated, and the slider can slide down along the sliding groove of the clamping arm to abut against the lower clamping portion, so that the lower clamping portion is separated from the clamping arm.

As a further preferred solution of the utility model, the lower clamping portion is opened and provided with an accommodating through hole adapted to the connecting head and used for accommodating the connecting head.

As a further preferred solution of the utility model, the connecting member is rotatably connected to the slider via a rotating shaft of the clamping arm.

As a further preferred solution of the utility model, an anti-swaying structure for preventing the clamping arm from swaying relative to the slider is provided on the rotating shaft of the clamping arm.

As a further preferred solution of the utility model, the anti-swaying structure comprises a compression spring sleeved on the rotating shaft of the clamping arm. One end of the compression spring is arranged on the clamping arm, and the other end thereof abuts against the slider, so that one end of the slider is pressed tightly against a wall of the sliding groove of the clamping arm.

As a further preferred solution of the utility model, the anti-swaying structure further includes a plurality of anti-swaying protrusions arranged in a circular array on the connecting member with the rotating shaft of the clamping arm as a center of a circle, and a plurality of anti-swaying grooves matched with the plurality of anti-swaying protrusions on the slider.

As a further preferred solution of the utility model, the lower clamping portion and the upper clamping portion are provided with a first anti-skid groove and a second anti-skid groove, respectively.

The beneficial effects of the present utility model are as follows: the utility model provides the clamping device. The sliding groove of the clamping arm is arranged on the clamping arm. The slider is slidably arranged in the sliding groove of the clamping arm, so that the connecting member is rotatably connected to the slider. Therefore, after clamping the photographing apparatus, the clamping device can conveniently adjust horizontally a photographing angle. The clamping device is easy to be stored, thereby reducing a volume of the self-photographing apparatus, which is convenient to carry and use.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic structural diagram of a storage state of a clamping device of an embodiment of the utility model;

FIG. 2 is a schematic structural diagram of an unfolded state of a clamping device of an embodiment of the utility model;

FIG. 3 is an exploded schematic diagram of a clamping device of an embodiment of the utility model;

FIG. 4 is a view of another angle of FIG. 3;

FIG. 5 is a sectional diagram of an unfolded state of a clamping device of an embodiment of the utility model; and

FIG. 6 is an enlarged schematic diagram of A of FIG. 5.

### DETAILED DESCRIPTION

The utility model provides a clamping device. To make the objective, technical solution and effect of the utility model clearer, the utility model is described in further details below with reference to the accompanying drawings and embodiments. It should be understood that the specific embodiments described herein are only used to explain the utility model, and are not intended to limit the utility model.

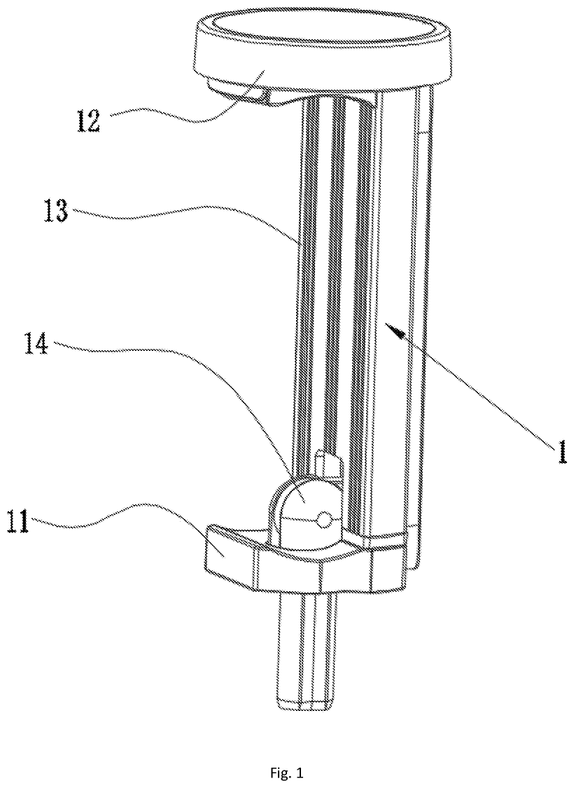

As shown in FIGS. 1-6, An embodiment of the utility model provides a clamping device 1, including a lower clamping portion 11, an upper clamping portion 12 corresponding to the lower clamping portion 11, a clamping arm 13 connecting the upper clamping portion 12 with the upper clamping portion 11, and a connecting head 14 for connecting a selfie rod. The clamping device 1 further includes a connecting member 15 arranged on one side of the connecting head 14. A sliding groove 131 of the clamping arm is provided on one side of the clamping arm 13 far away from the connecting head 14. A slider 16 is slidably arranged in the sliding groove 131 of the clamping arm, and the connecting member 15 is rotatably connected to the slider 16. The rotational connection is preferably a hinge. In the utility model, the slider 16 is slidably arranged in the sliding groove 131 of the clamping arm 13, so that the connecting member 15 is rotatably connected to the slider 16. Therefore, after clamping the photographing apparatus, the clamping device 1 can conveniently adjust horizontally a photographing angle. The clamping device is easy to be stored, thereby reducing a volume of the self-photographing apparatus, which is convenient to carry and use. It should be noted that in this embodiment, the connecting member 15 is arranged on an outer side (the side away from a peripheral device) of the clamping arm 13. When the clamping arm 13 needs to be rotated, a certain space is required for rotation. The sliding groove 131 of the clamping arm cooperates with the slider 16. The sliding groove 131 can be slid downward to be folded and stored during storage, and can be slid upward to provide a space for the clamping arm 13 to rotate and adjust an angle during use. Therefore, under the premise of no affecting a normal angle adjustment function, the utility model further improves a folding effect of the clamping device 1, that is, the volume of the selfie device is reduced.

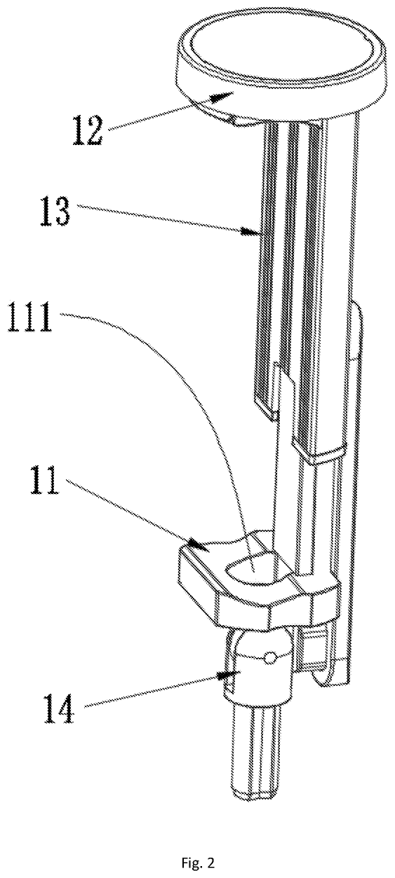

Further, as shown in FIG. 1 and FIG. 2, the upper clamping portion 12 is fixed at one end of the clamping arm, and the lower clamping portion 11 is slidably arranged at the other end of the clamping arm 13. In this embodiment, an elastic mechanism for driving the lower clamping portion 11 to press the clamping arm 13 is further provided between the lower clamping portion 11 and the clamping arm 13. Since the lower clamping portion 11 is slidably arranged on one end of the clamping arm 13 and cooperates with the upper clamping portion 12, the photographing apparatus can be clamped.

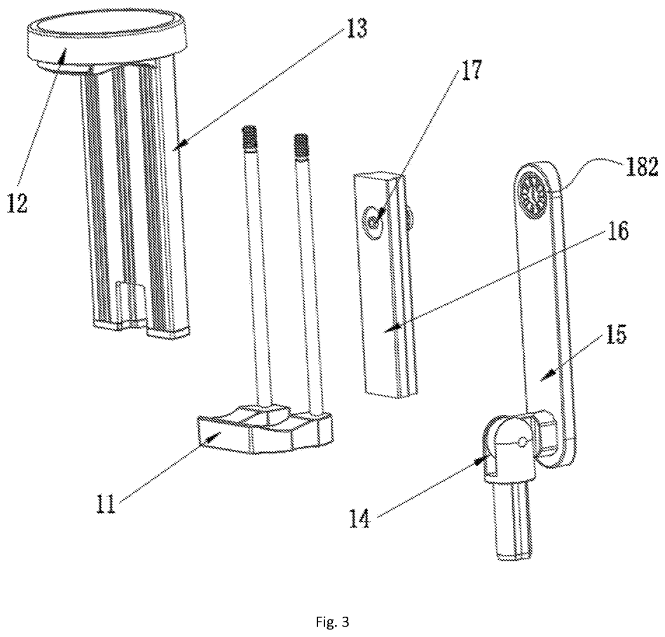

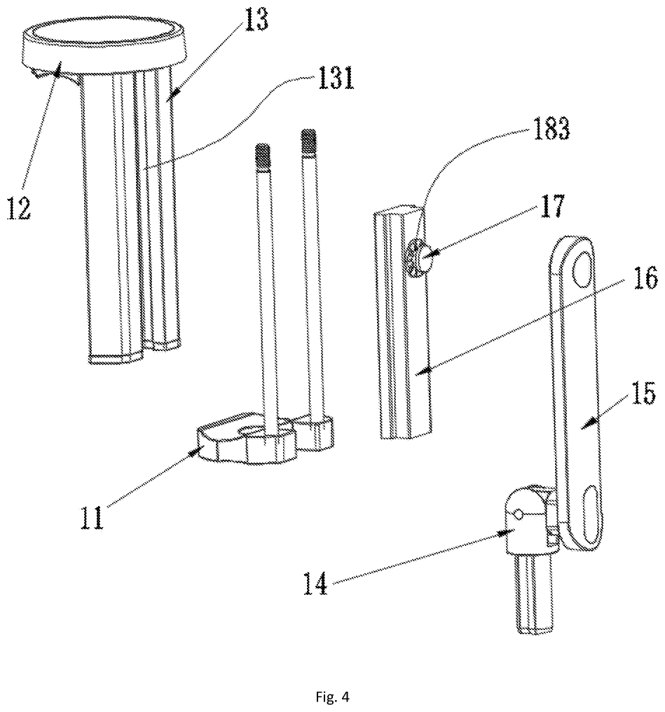

Further, as shown in FIG. 1, FIG. 2, FIG. 3, and FIG. 4, the slider 16 is elongated, and the slider 16 can be slid down along the sliding groove 131 of the clamping arm to abut against the lower clamping portion 11, so that the lower clamping portion 11 is separated from the clamping arm 13. Since the slider 16 is arranged in an elongated shape, a contact area between the slider 16 and the sliding groove 131 of the clamping arm can be increased, and the stability of the slider 16 when sliding can be improved. At the same time, when the photographing apparatus is clamped, the upper clamping portion 12 and the clamping arm 13 can be pulled upward to drive the lower clamping portion 11 to move up. After the lower clamping portion 11 is moved to contact with the slider 16, under blocking of the slider 16, the lower clamping portion 11 is far away from the clamping arm 13 to place the photographing apparatus (at this time, the slider 16 is only partially separated from the sliding groove 131 of the clamping arm), which can effectively prevent a user from being pinched by the lower clamping portion 11 and the clamping arm 13 when the user separates the lower clamping portion 11 and the clamping arm 13, thereby improving the safety of the clamping device.

Further, as shown in FIG. 1 and FIG. 2, the lower clamping portion 11 is opened and provided with an accommodating through hole 111 adapted to the connecting head 14 and used for accommodating the connecting head 14. When the clamping device is stored and carried, the connecting head 14 can be accommodated in the accommodating through hole 111. Therefore, a structure is more compact, and appearance is beautiful.

Further, as shown in FIG. 1, FIG. 2, FIG. 3, and FIG. 4, the connecting member 15 is rotatably connected to the slider 16 via a rotating shaft 17 of the clamping arm. In this embodiment, one end of the rotating shaft 17 of the clamping arm is fixedly connected to the connecting member 15, and the other end thereof is rotatably connected to the slider 16. By adding one rotating shaft 17 of the clamping arm, the connecting member 15 can be rotatably connected to the slider 16. In other embodiments, one end of the rotating shaft 17 of the clamping arm can be fixed on the slider 16, and the other end thereof is rotatably connected to the connecting member, which can also realize a function of rotating connection.

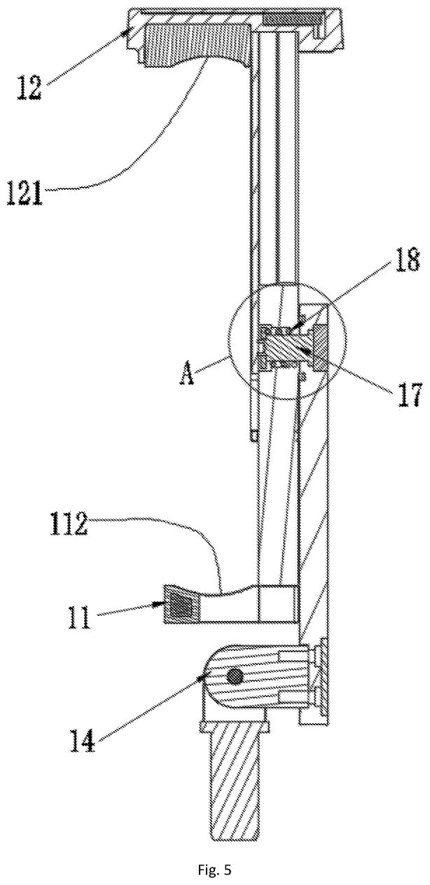

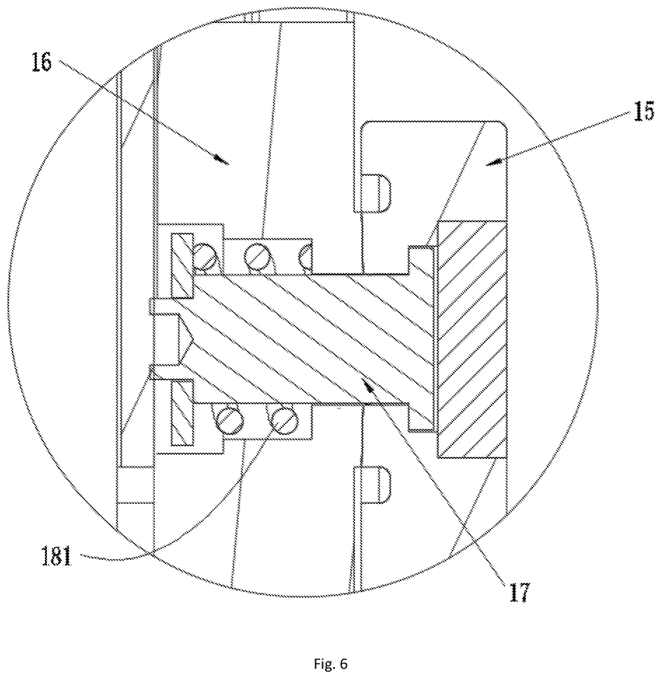

Further, as shown in FIG. 5 and FIG. 6, an anti-swaying structure 18 for preventing the clamping arm 13 from swaying relative to the slider 16 is provided on the rotating shaft 17 of the clamping arm. Since the anti-swaying structure 18 is arranged, stability of the clamping device 1 can be improved, and a photographing effect can be improved.

Further, as shown in FIG. 5 and FIG. 6, the anti-swaying structure 18 comprises a compression spring 181 sleeved on the rotating shaft 17 of the clamping arm. One end of the compression spring 181 is arranged on the clamping arm 13, and the other end thereof abuts against the slider 16, so that one end of the slider 16 is pressed tightly against a wall of the sliding groove 131 of the clamping arm. Since the compression spring 181 is compressed to provide a pressing force, the slider 16 is pressed against the sliding groove 131 of the clamping arm, and the stability of the clamping device 1 is improved.

Further, as shown in FIG. 3, FIG. 4, FIG. 5, and FIG. 6, the anti-swaying structure 18 further comprises a plurality of anti-swaying protrusions 182 arranged in a circular array on the connecting member with the rotating shaft 17 of the clamping arm as a center of a circle, and a plurality of anti-swaying grooves 183 matched with the plurality of anti-swaying protrusions 182 on the slider. By adding the plurality of anti-sway protrusions 182 and the plurality of anti-sway grooves 183, the clamping arm 13 can be fixed after being rotated by a certain angle, so as to prevent the clamping arm 13 from loosening and rotating when the clamping device 1 is in use, which affects proper work of the photographing.

Further, as shown in FIG. 5, the lower clamping portion 11 and the upper clamping portion 12 are provided with a first anti-skid groove 112 and a second anti-skid groove 121, respectively. By adding the first anti-skid groove 112 and the second anti-slip groove 121, the stability of clamping the photographing apparatus can be improved.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A clamping device, comprising a lower clamping portion, an upper clamping portion corresponding to the lower clamping portion, a clamping arm connecting the upper clamping portion with the upper clamping portion, and a connecting head for connecting a telescopic rod, wherein the clamping device further comprises a connecting member arranged on one side of the connecting head, a sliding groove of the clamping arm is provided on one side of the clamping arm far away from the connecting head, a slider is slidably arranged in the sliding groove of the clamping arm, the connecting member is rotatably connected to the slider; and the connecting member and the lower clamping portion are arranged on front and rear sides of the clamping arm, respectively.

2. The clamping device according to claim 1, wherein the upper clamping portion is fixed at one end of the clamping arm, and the lower clamping portion is slidably arranged at the other end of the clamping arm.

3. The clamping device according to claim 2, wherein the slider is elongated, and the slider can slide down along the sliding groove of the clamping arm to abut against the lower clamping portion, so that the lower clamping portion is separated from the clamping arm.

4. The clamping device according to claim 1, wherein the lower clamping portion is opened and provided with an accommodating through hole adapted to the connecting head and used for accommodating the connecting head.

5. The clamping device according to claim 1, wherein the connecting member is rotatably connected to the slider via a rotating shaft of the clamping arm.

6. The clamping device according to claim 5, wherein an anti-swaying structure for preventing the clamping arm from swaying relative to the slider is provided on the rotating shaft of the clamping arm.

7. The clamping device according to claim 6, wherein the anti-swaying structure comprises a compression spring sleeved on the rotating shaft of the clamping arm; one end of the compression spring is arranged on the clamping arm, and the other end thereof abuts against the slider, so that one end of the slider is pressed tightly against a wall of the sliding groove of the clamping arm.

8. The clamping device according to claim 7, wherein the anti-swaying structure further comprises a plurality of anti-swaying protrusions arranged in a circular array on the connecting member with the rotating shaft of the clamping arm as a center of a circle, and a plurality of anti-swaying grooves matched with the plurality of anti-swaying protrusions on the slider.

9. The clamping device according to claim 1, wherein the lower clamping portion and the upper clamping portion are provided with a first anti-skid groove and a second anti-skid groove, respectively.
